(19) United States
(12) Patent Application Publication
(10) Pub. No.: US 2025/0292952 A1
(43) Pub. Date: Sep. 18, 2025

(54) MULTILAYER COIL COMPONENT

(71) Applicant: TDK Corporation, Tokyo (JP)

(72) Inventors: So KOBAYASHI, Tokyo (JP); Youichi KAZUTA, Tokyo (JP); Yuto SHIGA, Tokyo (JP); Yuichi TAKUBO, Tokyo (JP); Xuran GUO, Tokyo (JP); Teru ISHIMORI, Tokyo (JP)

(73) Assignee: TDK Corporation, Tokyo (JP)

(21) Appl. No.: 19/073,368

(22) Filed: Mar. 7, 2025

(30) Foreign Application Priority Data
Mar. 13, 2024 (JP) 2024-039289

(51) Int. Cl. H01F 27/29

(52) U.S. Cl. CPC H01F 27/292

(57) ABSTRACT

A multilayer coil component includes: an element body including a first main surface and a second main surface facing each other, a first end surface and a second end surface facing each other, and a first side surface and a second side surface facing each other; a first external electrode; a second external electrode; and a coil having a first end connected to the first external electrode, and a second end connected to the second external electrode. A coil axis of the coil extends in a facing direction of the first side surface and the second side surface. The coil extends from the first end to pass between the coil axis and the first main surface and reach between the coil axis and the second end surface.

### TECHNICAL FIELD

The present disclosure relates to a multilayer coil component. The present application claims priority to Japanese Patent Application No. 2024-039289 filed on Mar. 13, 2024, the content of which is incorporated herein by reference in its entirety.

### BACKGROUND

A multilayer coil component including an element body, an external electrode provided in the element body, and a coil disposed inside the element body is known (e.g., Japanese Unexamined Patent Publication No. 2021-34667). In this multilayer coil component, the external electrode is embedded in the element body so as to be exposed from the main surface and the end surface of the element body.

### SUMMARY

When the multilayer coil component above is solder mounted to an electronic device and a bond strength test to the electronic device is performed, the element body may detach from the external electrode and become damaged. To prevent such damage, it is desired to improve the adhesion between the external electrode and the element body to improve the bond strength of the multilayer coil component to the electronic device substrate.

It is an object of the present disclosure to provide a multilayer coil component that is capable of improving the adhesion between an external electrode and an element body.

The present inventors have found that when a bond strength test to a substrate is performed on the multilayer coil component above, the element body becomes damaged in the vicinity of the external electrode and detaches from the external electrode.
(1) A multilayer coil component according to an embodiment of the present disclosure includes: an element body including a first main surface and a second main surface facing each other, a first end surface and a second end surface facing each other, and a first side surface and a second side surface facing each other; a first external electrode embedded in the element body to be exposed from the first end surface and the first main surface; a second external electrode embedded in the element body to be exposed from the second end surface and the first main surface; and a coil having a first end connected to the first external electrode, and a second end connected to the second external electrode, wherein a coil axis of the coil extends in a facing direction of the first side surface and the second side surface, and wherein the coil extends from the first end to pass between the coil axis and the first main surface and reach between the coil axis and the second end surface.

In this multilayer coil component, the coil extends from the first end connected to the first external electrode so as to pass between the coil axis and the first main surface and reach between the coil axis and the second end surface. In this configuration, more conductors tend to be disposed in the vicinity of the first external electrode and the second external electrode compared to a configuration in which the coil extends from the first end, passing between the coil axis and the second main surface and reaching between the coil axis and the second end surface. The conductors are harder than the element body, so that by more conductors being disposed in the vicinity of the first external electrode and the second external electrode, damage to the element body in the vicinity of the first external electrode and the second external electrode is suppressed. Consequently, the adhesion between the element body and the first and second external electrodes can be improved.
(2) The multilayer coil component of (1) above may further include a first connecting conductor connecting the first end and the first external electrode, wherein the coil may include a coil portion disposed close to the first main surface, and wherein the first connecting conductor may be connected to the coil portion. In this case, even more conductors are disposed in the vicinity of the first external electrode. Consequently, the adhesion between the element body and the first external electrode can be further improved.
(3) The multilayer coil component of (2) above may further include a second connecting conductor connecting the second end and the second external electrode, wherein the second connecting conductor may be connected to the coil portion. In this case, even more conductors are disposed in the vicinity of the second external electrode. Consequently, the adhesion between the element body and the second external electrode can be further improved.
(4) The multilayer coil component of any one of (1) to (3) above may further include a first connecting conductor connecting the first end and the first external electrode, wherein the first external electrode may include a first electrode portion provided on the first end surface, and a second electrode portion provided on the first main surface, and wherein the first connecting conductor may be connected to the first electrode portion. In this case, the first connecting conductor tends to be long. Thus, since even more conductors are disposed in the vicinity of the first external electrode, the adhesion between the element body and the first external electrode can be further improved.
(5) In the multilayer coil component of (4) above, the first connecting conductor may also be connected to the second electrode portion. In this case, even more conductors are disposed in the vicinity of the first external electrode. Consequently, the adhesion between the element body and the first external electrode can be further improved.
(6) In the multilayer coil component of (4) or (5) above, the first connecting conductor may be connected to the first electrode portion at a position closer to the first main surface than the second main surface in a facing direction of the first main surface and the second main surface. In this case, even more conductors are disposed in the vicinity of the first external electrode. Consequently, the adhesion between the element body and the first external electrode can be further improved.

### BRIEF DESCRIPTION OF THE DRAWINGS

FIG. 1 is a perspective view of a multilayer coil component according to an embodiment.

FIG. 2 is a plan view of the multilayer coil component of FIG. 1 as viewed from a main surface 2a.

FIG. 3 is a plan view of the multilayer coil component of FIG. 1 as viewed from a side surface 2c.

FIG. 4 is an exploded view of the multilayer coil component of FIG. 1.

FIG. 5 is a plan view of a multilayer coil component according to a comparative example.

FIG. 6 is an exploded view of a multilayer coil component according to a variation.

### DETAILED DESCRIPTION

Embodiments will be described below with reference to the drawings. Same reference signs are given to the same or corresponding elements in the description of the drawings, and redundant description will be omitted as appropriate.

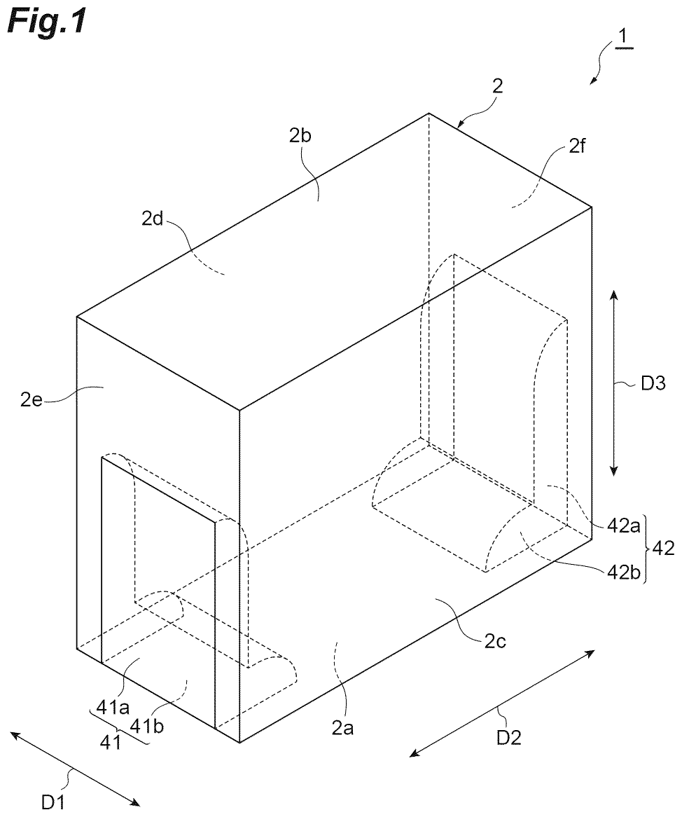

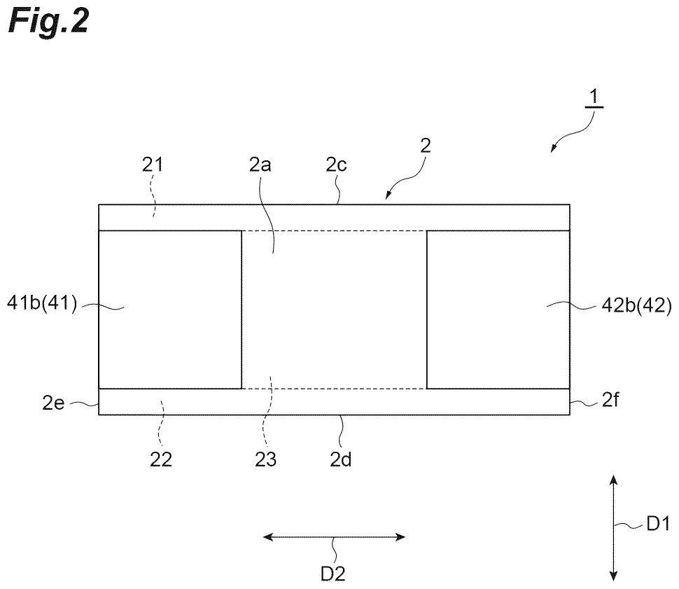

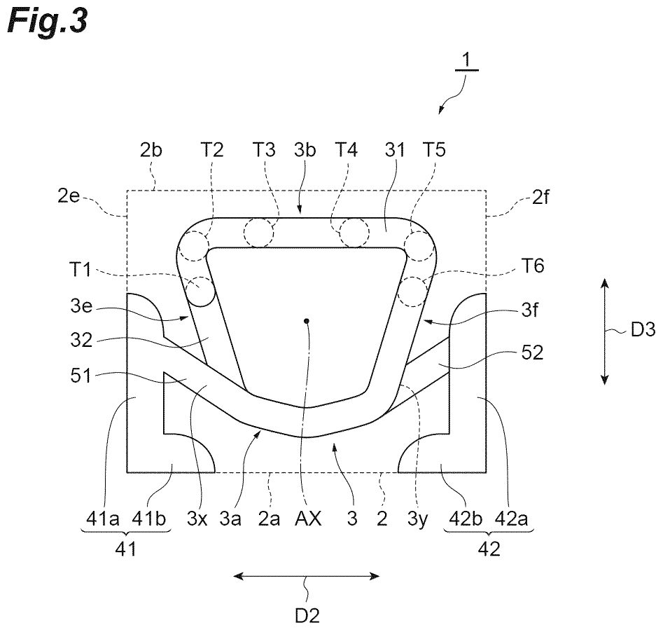

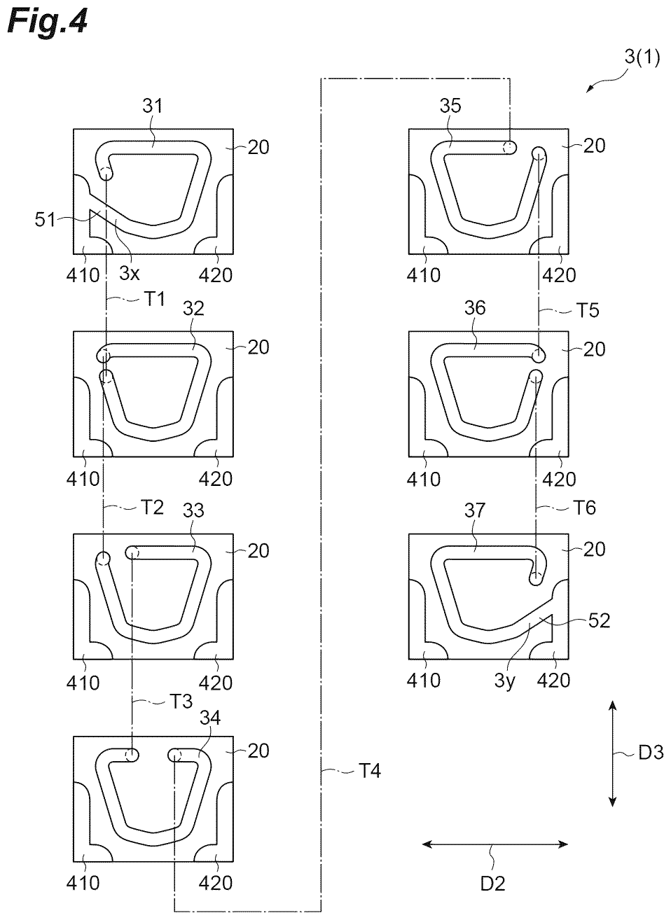

The configuration of a multilayer coil component 1 according to this embodiment will be described with reference to FIGS. 1 to 4. FIG. 1 is a perspective view of the multilayer coil component according to the embodiment. FIG. 2 is a plan view of the multilayer coil component of FIG. 1 as viewed from a main surface 2a. FIG. 3 is a plan view of the multilayer coil component of FIG. 1 as viewed from a side surface 2c. In FIG. 3, an element body 2 is illustrated in broken lines. FIG. 4 is an exploded view of the multilayer coil component of FIG. 1. The multilayer coil component 1 according to this embodiment is solder mounted to an electronic device. The electronic device includes, for example, a circuit board or an electronic component. The multilayer coil component 1 is, for example, a high frequency inductor.

As illustrated in FIGS. 1 to 3, the multilayer coil component 1 includes the element body 2, a coil 3 disposed inside the element body 2, a pair of external electrodes 41, 42 disposed on surfaces of the element body 2, and a pair of connecting conductors 51, 52 disposed inside the element body 2. The external electrodes 41, 42 are electrically connected to the coil 3. The element body 2 has a rectangular parallelepiped shape. The rectangular parallelepiped shape includes a rectangular parallelepiped shape in which the corners and edges are chamfered, and a rectangular parallelepiped shape in which the corners and edges are rounded.

The element body 2 has a pair of main surfaces 2a, 2b that face each other, a pair of side surfaces 2c, 2d that face each other, and a pair of end surfaces 2e, 2f that face each other. The main surfaces 2a, 2b, the side surfaces 2c, 2d, and the end surfaces 2e, 2f have rectangular shapes. The main surfaces 2a, 2b adjoin the side surfaces 2c, 2d and the end surfaces 2e, 2f. The side surfaces 2c, 2d and the end surfaces 2e, 2f adjoin one another. When the multilayer coil component 1 is solder mounted to an electronic device, the main surface 2a faces the electronic device that is solder mounted. The main surfaces 2a, 2b, the side surfaces 2c, 2d, and the end surfaces 2e, 2f are planar. Planar refers to surfaces that are intended to be formed as planes, and it is not limited to geometrically perfect planes. The planar surfaces may include curves and unevenness that occur during the manufacturing process.

A direction D3 in which the pair of main surfaces 2a, 2b face each other is perpendicular to the main surfaces 2a, 2b. A direction D1 in which the pair of side surfaces 2c, 2d face each other is perpendicular to the side surfaces 2c, 2d. A direction D2 in which the pair of end surfaces 2e, 2f face each other is perpendicular to the end surfaces 2e, 2f. The direction D3 is perpendicular to the direction D1 and the direction D2. The direction D1 and the direction D2 are perpendicular to each other. The element body 2 has a pair of recesses corresponding to the pair of external electrodes 41, 42.

As illustrated in FIG. 4, the element body 2 includes a plurality of insulator layers 20 that are laminated in the direction D1. The plurality of insulator layers 20 are integrated such that the boundaries between the insulator layers 20 cannot be visually recognized. Each of the insulator layers 20 is formed, for example, of a non-magnetic material. The non-magnetic material includes, for example, a glass ceramic material or a dielectric material. The glass component is, for example, borosilicate glass. The dielectric material is, for example, a BaTiO₃, Ba(Ti, Zr)O₃, or (Ba, Ca)TiO₃ dielectric ceramic. In this embodiment, each of the insulator layers 20 is formed of a sintered body of a green sheet including a non-magnetic material. Each of the insulator layers 20 may be formed of a magnetic material.

The plurality of insulator layers 20 include a pair of outer layers 21, 22 illustrated in FIG. 2 (not shown in FIG. 4). The outer layers 21, 22 are positioned on both ends in the direction D1 and form the outermost layers of the element body 2. The outer layer 21 has the side surface 2c. The outer layer 22 has the side surface 2d. The remaining plurality of insulator layers 20 are disposed between the outer layers 21, 22 in the direction D1 and form a laminate 23 illustrated in FIG. 2. The outer layers 21, 22 have higher rigidity than the laminate 23, and is thus capable of suppressing damage to the element body 2. The rigidity can be adjusted, for example, by the content of a filler. The coil 3, the external electrodes 41, 42, and the connecting conductors 51, 52 are disposed inside the laminate 23, and are not disposed in the outer layers 21, 22.

The plurality of insulator layers 20 have equal thicknesses. In this specification, the term “equal” does not necessarily only mean that the values are the same. Values can be equal to each other even when they include minute differences, manufacturing errors, or measurement errors within a preset range. The outer layers 21, 22 may have a thickness that is different from the thickness of the insulator layers 20 that form the laminate 23.

The external electrode 41 is embedded in the element body 2 so as to be exposed from the end surface 2e and the main surface 2a. The external electrode 42 is embedded in the element body 2 so as to be exposed from the end surface 2f and the main surface 2a. The external electrodes 41, 42 have an L-shaped cross-section when viewed in the direction D1. The recesses formed in the element body 2 and corresponding to the external electrodes 41, 42 have an L-shape when viewed in the direction D1.

The external electrode 41 includes an electrode portion 41a and an electrode portion 41b. The electrode portion 41a is exposed from the end surface 2e. The electrode portion 41b is exposed from the main surface 2a. The surface of the electrode portion 41a is oriented in the same direction as the end surface 2e. The surface of the electrode portion 41b is oriented in the same direction as the main surface 2a. The electrode portion 41a and the electrode portion 41b continue so as to follow along the edge portion between the end surface 2e and the main surface 2a.

The external electrode 42 includes an electrode portion 42a and an electrode portion 42b. The electrode portion 42a is exposed from the end surface 2f. The electrode portion 42b is exposed from the main surface 2a. The surface of the electrode portion 42a is oriented in the same direction as the end surface 2f. The surface of the electrode portion 42b is oriented in the same direction as the main surface 2a. The electrode portion 42a and the electrode portion 42b continue so as to follow along the edge portion between the end surface 2f and the main surface 2a

In this embodiment, the external electrodes 41, 42 have a length in the direction D3 greater than a length of the external electrodes 41, 42 in the direction D2. The electrode portions 41b, 42b are disposed so as to be exposed in the same orientation as the main surface 2a. The surfaces of the electrode portions 41b, 42b may be positioned on the same plane as the main surface 2a. The surfaces of the electrode portions 41b, 42b may protrude from the main surface 2a. The electrode portion 41a is disposed so as to be exposed in the same orientation as the end surface 2e. The surface of the electrode portion 41a may be positioned on the same plane as the end surface 2e. The surface of the electrode portion 41a may protrude from the end surface 2e. The electrode portion 42a is disposed on the end surface 2f so as to be exposed in the same orientation as the end surface 2f. The surface of the electrode portion 42a may be positioned on the same plane as the end surface 2f. The surface of the electrode portion 42a may protrude from the end surface 2f. In this embodiment, the electrode portions 41a, 42a have a length in the direction D3 greater than a length of the electrode portions 41b, 42b in the direction D2.

As illustrated in FIG. 3, the coil 3 is connected to the external electrodes 41, 42 (see FIG. 1). The coil 3 has a first end 3x and a second end 3y. The first end 3x is connected to the external electrode 41 by the connecting conductor 51. The second end 3y is connected to the external electrode 42 by the connecting conductor 52. A coil axis AX of the coil 3 extends along the direction D1. The coil 3 is disposed inside the element body 2 and is not exposed from the element body 2.

The coil 3 is wound counterclockwise around the coil axis AX when viewed from the side surface 2c. From the first end 3x, the coil 3 repeatedly passes sequentially between the coil axis AX and the main surface 2a, between the coil axis AX and the end surface 2f, between the coil axis AX and the main surface 2b, and between the coil axis AX and the end surface 2e, and reaches the second end 3y. From the second end 3y, the coil 3 repeatedly passes sequentially between the coil axis AX and the main surface 2a, between the coil axis AX and the end surface 2e, between the coil axis AX and the main surface 2b, and between the coil axis AX and the end surface 2f, and reaches the first end 3x.

The coil 3 has an annular shape when viewed in the direction D1. The coil 3 has a pentagonal shape when viewed in the direction D1. This pentagon is symmetrical in the direction D2 about a center line along the direction D3. The pentagon includes a first side positioned closest to the main surface 2b, a second side positioned closest to the end surface 2f, third and fourth sides positioned closest to the main surface 2a, and a fifth side positioned closest to the end surface 2e. The first and second sides are connected at a first vertex, the second and third sides are connected at a second vertex, the third and fourth sides are connected at a third vertex, the fourth and fifth sides are connected at a fourth vertex, and the fifth and first sides are connected at a fifth vertex. The second and fifth sides are symmetrical with each other and the third and fourth sides are symmetrical with each other about a center line that passes through the third vertex between the third and fourth sides. The first side is longer than the second side and longer than the fifth side. The second and fifth sides are each longer than the third side and longer than the fourth side.

The first side extends parallel to the direction D2. The second side is inclined with respect to the direction D3 so as to gradually separate from the end surface 2f from the first side toward the third side. The third side is inclined with respect to the direction D2 so as to gradually approach the main surface 2a from the second side toward the fourth side. The fourth side is inclined with respect to the direction D2 so as to gradually separate from the main surface 2a from the third side toward the fifth side. The fifth side is inclined with respect to the direction D3 so as to gradually approach the end surface 2e from the fourth side toward the first side.

The coil 3 has coil portions 3a, 3b, 3e, 3f. The coil portion 3a and the coil portion 3b face each other in the direction D3. The coil portion 3a is disposed close to the main surface 2a and includes the third and fourth sides. The coil portion 3a extends between the coil axis AX and the main surface 2a. The coil portion 3b is disposed close to the main surface 2b and includes the first side. The coil portion 3b extends between the coil axis AX and the main surface 2b. The coil portion 3e and the coil portion 3f face each other in the direction D2. The coil portion 3e is disposed close to the end surface 2e and includes the fifth side. The coil portion 3e extends between the coil axis AX and the end surface 2e. The coil portion 3f is disposed close to the end surface 2f and includes the second side. The coil portion 3f extends between the coil axis AX and the end surface 2f.

Each of the coil portions 3a, 3b adjoins the coil portion 3e and the coil portion 3f. Each of the coil portions 3a, 3b connects the coil portion 3e and the coil portion 3f. Each of the coil portions 3e, 3f adjoins the coil portion 3a and the coil portion 3b. Each of the coil portions 3e, 3f connects the coil portion 3a and the coil portion 3b.

As illustrated in FIG. 4, the coil 3 has a plurality of coil conductors 31 to 37 and a plurality of through hole conductors T1 to T6. The plurality of coil conductors 31 to 37 are electrically connected to each other by the plurality of through hole conductors T1 to T6.

As illustrated in FIGS. 3 and 4, the connecting conductor 51 electrically connects the first end 3x of the coil 3 and the external electrode 41 to each other. The first end 3x of the coil 3 and the external electrode 41 are physically connected to each other via the connecting conductor 51. The connecting conductor 51 extends from the electrode portion 41a toward the main surface 2a and is connected to the first end 3x. The connecting conductor 52 electrically connects the second end 3y of the coil 3 and the external electrode 42 to each other. The second end 3y of the coil 3 and the external electrode 42 are physically connected to each other via the connecting conductor 52. The connecting conductor 52 extends from the electrode portion 42a toward the main surface 2a and is connected to the second end 3y.

In this embodiment, a lamination direction of the multilayer coil component 1 is along the direction D1. FIG. 4 illustrates a plurality of layers that form the multilayer coil component 1 as viewed in the direction D1. The plurality of layers that form the multilayer coil component 1 include the insulator layers 20, the layers that form the coil conductors 31 to 37, the through hole conductors T1 to T6, and the external electrodes 41, 42, and the connecting conductors 51, 52. FIG. 4 illustrates seven layers including the coil conductors 31 to 37 among the plurality of layers that form the multilayer coil component 1, and the remaining layers are omitted.

The external electrodes 41, 42 are formed of a plurality of laminated electrode layers 410, 420, respectively. In the actual external electrode 41, the electrode layers 410 are integrated such that the boundaries between each of the electrode layers 410 cannot be visually recognized. In the actual external electrode 42, the electrode layers 420 are integrated such that the boundaries between each of the electrode layers 420 cannot be visually recognized. The electrode layers 410, 420 are provided in cutout portions formed in the corresponding insulator layers 20. A pair of recesses corresponding to the external electrodes 41, 42 is obtained by the cutout portions formed in the insulator layers 20. Each of the electrode layers 410, 420 is formed, for example, of a conductive material. The conductive material includes, for example, Ag or Pd. In this embodiment, each of the electrode layers 410, 420 is formed of a sintered body of a conductive paste including a conductive material powder.

The connecting conductors 51, 52 are provided in cutout portions formed in the corresponding insulator layers 20. The connecting conductors 51, 52 are formed, for example, of the same material as each of the electrode layers 410, 420. Each of the connecting conductors 51, 52 is formed, for example, of a sintered body of a conductive paste. The coil conductors 31 to 37 are provided in cutout portions formed in the corresponding insulator layers 20. The coil conductors 31 to 37 are formed, for example, of the same material as each of the electrode layers 410, 420. Each of the coil conductors 31 to 37 is formed, for example, of a sintered body of a conductive paste.

The coil conductors 31 to 37 form parts of the annular track of the coil 3. The coil conductors 31 to 37 have, for example, shapes in which part of a loop is missing. Each of the coil conductors 31 to 37 has a path length and a thickness. The path length of each of the coil conductors 31 to 37 is, for example, 80% or more of a length of a single turn of the coil 3. That is, the gap between the ends of each of the coil conductors 31 to 37 is, for example, less than 20% of the length of a single turn of the coil 3.

The coil conductors 31 to 37 have equal widths. The width of the coil conductors 31 to 37 is the length of the coil conductors 31 to 37 in a direction perpendicular to the direction D1 and perpendicular to the path of the coil conductors 31 to 37. The coil conductors 31 to 37 have equal thicknesses. The thickness of the coil conductors 31 to 37 is the length of the coil conductors 31 to 37 in the direction D1. Layers of the coil conductors 31 to 37 correspond respectively to the layers that form the multilayer coil component 1. Each of the layers of the coil conductors 31 to 37 extends along a plane that intersects the direction D1 in which the coil conductors 31 to 37 are arranged. In this embodiment, each of the layers of the coil conductors 31 to 37 extends along the direction D2 and the direction D3.

The coil conductors 31 to 37 are arranged in the direction D1 in this order. The coil conductor 31 includes the first end 3x of the coil 3. The coil conductor 31 is connected to the electrode portion 41a of the external electrode 41 by the connecting conductor 51. The connecting conductor 51 is connected to the electrode portion 41a at a position closer to the main surface 2a than the main surface 2b in the direction D3. The coil conductor 31 is included in the same layer as the connecting conductor 51. The coil conductor 31 adjoins the outer layer 21 in the direction D1.

The coil conductor 37 includes the second end 3y of the coil 3. The coil conductor 37 is connected to the electrode portion 42a of the external electrode 42 by the connecting conductor 52. The connecting conductor 52 is connected to the electrode portion 42a at a position closer to the main surface 2a than the main surface 2b in the direction D3. The coil conductor 37 is included in the same layer as the connecting conductor 52. The coil conductor 37 adjoins the outer layer 22 in the direction D1.

The coil conductors 31, 32 are provided along a part of the coil portion 3e and the entire lengths of the coil portions 3a, 3f, 3b. The coil conductors 33 to 35 are provided along a part of the coil portion 3b and the entire lengths of the coil portions 3e, 3a, 3f. The coil conductors 36, 37 are provided along a part of the coil portion 3f and the entire lengths of the coil portions 3e, 3a, 3b.

The through hole conductors T1 to T6 are provided respectively in six layers disposed between the seven layers including the coil conductors 31 to 37 among the plurality of layers that form the multilayer coil component 1. The through hole conductor T1 extends in the direction D1 and connects the end portions of the coil conductors 31, 32 to each other. The through hole conductor T2 extends in the direction D1 and connects the end portions of the coil conductors 32, 33 to each other. The through hole conductor T3 extends in the direction D1 and connects the end portions of the coil conductors 33, 34 to each other. The through hole conductor T4 extends in the direction D1 and connects the end portions of the coil conductors 34, 35 to each other. The through hole conductor T5 extends in the direction D1 and connects the end portions of the coil conductors 35, 36 to each other. The through hole conductor T6 extends in the direction D1 and connects the end portions of the coil conductors 36, 37 to each other.

The through hole conductors T1 to T6 are separated from each other and are arranged in this order along the path of the coil 3 when viewed in the direction D1. The through hole conductor T1 is disposed at the coil portion 3e. The through hole conductors T2 to T5 are disposed at the coil portion 3b. The through hole conductor T6 is disposed at the coil portion 3f. All of the through hole conductors T1 to T6 are disposed closer to the main surface 2b than the main surface 2a.

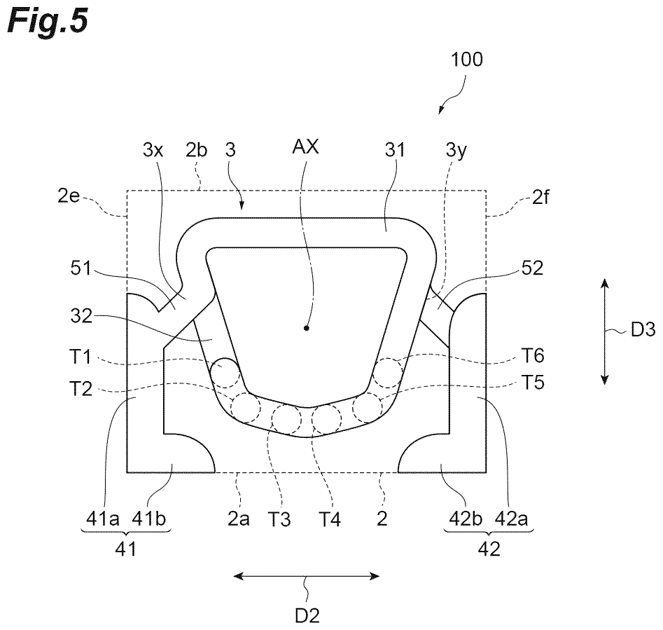

FIG. 5 is a plan view of a multilayer coil component according to a comparative example. A multilayer coil component 100 according to the comparative example illustrated in FIG. 5 is different from the multilayer coil component 1 illustrated in FIG. 3 in the shapes of the coil 3 and the connecting conductors 51, 52. In the multilayer coil component 100, the connecting conductor 51 extends toward the main surface 2b from the external electrode 41 and is connected to the first end 3x of the coil 3. The connecting conductor 52 extends toward the main surface 2b from the external electrode 42 and is connected to the second end 3y of the coil 3. The coil 3 is wound clockwise around the coil axis AX when viewed from the side surface 2c. The coil 3 extends from the first end 3x so as to pass between the coil axis AX and the main surface 2b and reach between the coil axis AX and the end surface 2f. The coil 3 extends from the second end 3y so as to pass between the coil axis AX and the main surface 2b and reach between the coil axis AX and the end surface 2e.

In contrast, in the multilayer coil component 1, the connecting conductor 51 extends toward the main surface 2a from the external electrode 41 and is connected to the first end 3x of the coil 3. The connecting conductor 52 extends toward the main surface 2a from the external electrode 42 and is connected to the second end 3y of the coil 3. The coil 3 is wound counterclockwise around the coil axis AX when viewed from the side surface 2c. The coil 3 extends from the first end 3x so as to pass between the coil axis AX and the main surface 2a and reach between the coil axis AX and the end surface 2f. The coil 3 extends from the second end 3y so as to pass between the coil axis AX and the main surface 2a and reach between the coil axis AX and the end surface 2e.

Compared to the multilayer coil component 100, in the multilayer coil component 1, more conductors tend to be disposed in the vicinity of the external electrodes 41, 42 and the conductor volume in the vicinity of the external electrodes 41, 42 tends to increase. The conductors are harder than the element body 2, so that by more conductors being disposed in the vicinity of the external electrodes 41, 42, damage to the element body 2 in the vicinity of the external electrodes 41, 42 is suppressed. Consequently, the adhesion between the element body 2 and the external electrodes 41, 42 can be improved.

In the multilayer coil component 1, the connecting conductor 51 is connected to the electrode portion 41a at a position closer to the main surface 2a than the main surface 2b. Thus, even more conductors are disposed in the vicinity of the external electrode 41. Consequently, the adhesion between the element body 2 and the external electrode 41 can be further improved. The connecting conductor 52 is connected to the electrode portion 42a at a position closer to the main surface 2a than the main surface 2b. Thus, even more conductors are disposed in the vicinity of the external electrode 42. Consequently, the adhesion between the element body 2 and the external electrode 42 can be further improved.

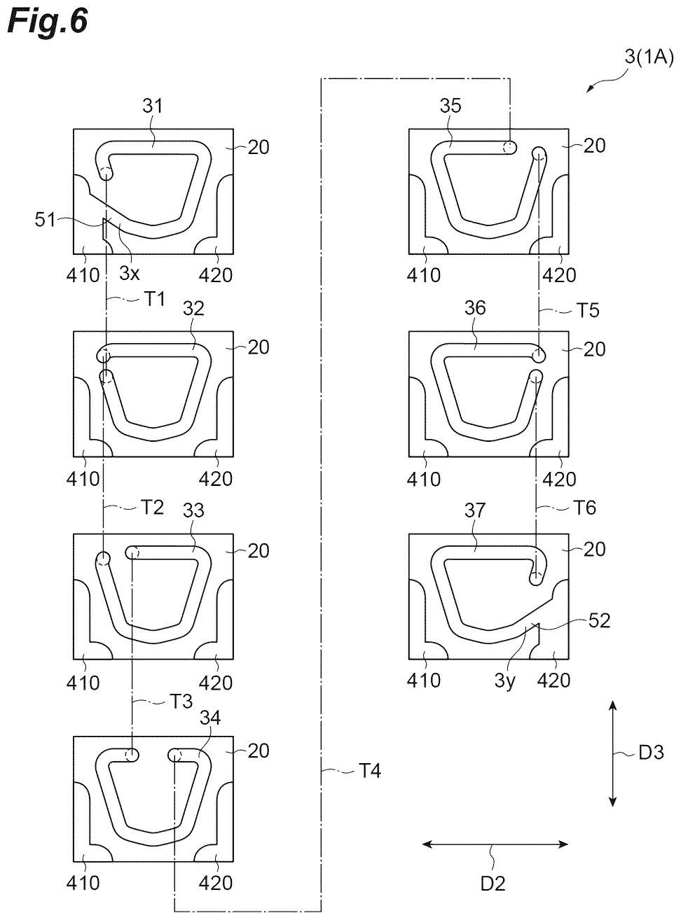

FIG. 6 is an exploded view of a multilayer coil component according to a variation. A multilayer coil component 1A according to the variation illustrated in FIG. 6 is different from the multilayer coil component 1 illustrated in FIG. 4 in that the connecting conductors 51, 52 are also connected to the electrode portions 41b, 42b. It can be said that, in the multilayer coil component 1A, the electrode layer 410 connected to the connecting conductor 51 among the electrode layers 410 that form the external electrode 41 has a width in the direction D2 that is greater than a width of the other electrode layers 410 in the direction D2. It can be said that the electrode layer 420 connected to the connecting conductor 52 among the electrode layers 420 that form the external electrode 42 has a width in the direction D2 that is greater than a width of the other electrode layers 420 in the direction D2. In the multilayer coil component 1A, even more conductors are disposed in the vicinity of the external electrodes 41, 42. Consequently, the adhesion between the element body 2 and the external electrodes 41, 42 can be further improved.

Although the embodiments have been described above, the present invention is not necessarily limited to these embodiments, and various modifications are possible without departing from the gist thereof. The embodiments and variations described above may be combined as appropriate.

Although in the multilayer coil component 1, the outer layers 21, 22 have high rigidity, they may have the same rigidity as the other insulator layers 20. The connecting conductor 51 may be connected to the coil portion 3a via the coil portion 3e, and the connecting conductor 52 may be connected to the coil portion 3a via the coil portion 3f. The connecting conductor 51 may be connected to the electrode portion 41a at a position closer to the main surface 2b than the main surface 2a in the direction D3. The connecting conductor 52 may be connected to the electrode portion 42a at a position closer to the main surface 2b than the main surface 2a in the direction D3.

What is claimed is:

1. A multilayer coil component comprising:
an element body including a first main surface and a second main surface facing each other, a first end surface and a second end surface facing each other, and a first side surface and a second side surface facing each other;
a first external electrode embedded in the element body to be exposed from the first end surface and the first main surface;
a second external electrode embedded in the element body to be exposed from the second end surface and the first main surface; and
a coil having a first end connected to the first external electrode, and a second end connected to the second external electrode,
wherein a coil axis of the coil extends in a facing direction of the first side surface and the second side surface, and
wherein the coil extends from the first end to pass between the coil axis and the first main surface and reach between the coil axis and the second end surface.

2. The multilayer coil component according to claim 1, further comprising a first connecting conductor connecting the first end and the first external electrode,
wherein the coil includes a coil portion disposed close to the first main surface, and
wherein the first connecting conductor is connected to the coil portion.

3. The multilayer coil component according to claim 2, further comprising a second connecting conductor connecting the second end and the second external electrode,
wherein the second connecting conductor is connected to the coil portion.

4. The multilayer coil component according to claim 1, further comprising a first connecting conductor connecting the first end and the first external electrode,
wherein the first external electrode includes a first electrode portion provided on the first end surface, and a second electrode portion provided on the first main surface, and
wherein the first connecting conductor is connected to the first electrode portion.

5. The multilayer coil component according to claim 4, wherein the first connecting conductor is also connected to the second electrode portion.

6. The multilayer coil component according to claim 4, wherein the first connecting conductor is connected to the first electrode portion at a position closer to the first main surface than the second main surface in a facing direction of the first main surface and the second main surface.

7. The multilayer coil component according to claim 1, wherein the coil extends from the second end to pass between the coil axis and the first main surface and reach between the coil axis and the first end surface.

8. The multilayer coil component according to claim 1, wherein the coil has a pentagonal shape when viewed from the facing direction.

9. The multilayer coil component according to claim 2, wherein the coil portion is bent toward the first main surface.

10. The multilayer coil component according to claim 1, a length of the first external electrode in a facing direction of the first end surface and the second end surface is shorter than a length of the first external electrode in a facing direction of the first main surface and the second main surface.

11. A multilayer coil component comprising:
an element body including a first main surface and a second main surface facing each other, a first end surface and a second end surface facing each other, and a first side surface and a second side surface facing each other;
a first external electrode embedded in the element body to be exposed from the first end surface and the first main surface; a second external electrode embedded in the element body to be exposed from the second end surface and the first main surface; and
a coil having a first end connected to the first external electrode, and a second end connected to the second external electrode,
wherein a coil axis of the coil extends in a facing direction of the first side surface and the second side surface,
wherein the coil has a pentagonal shape when viewed from the facing direction,
wherein the coil extends from the first end to pass between the coil axis and the first main surface and reach between the coil axis and the second end surface, and
wherein the coil extends from the second end to pass between the coil axis and the first main surface and reach between the coil axis and the first end surface.
